(19) United States
(12) Patent Application Publication
(10) Pub. No.: US 2011/0068974 A1
(43) Pub. Date: Mar. 24, 2011

(54) Inline GPS Receiver Module

(75) Inventors: Kevin J. Reese, Fayetteville, GA (US); Alfonso Jones, Suwanee, GA (US); Marty Turner, McDonough, GA (US)

(73) Assignee: AT&T INTELLECTUAL PROPERTY I, L.P., Reno, NV (US)

(21) Appl. No.: 12/566,301

(22) Filed: Sep. 24, 2009

(51) Int. Cl. G01S 19/03; G01S 19/35

(52) U.S. Cl. 342/357.4; 342/357.75

(57) ABSTRACT

Devices and methods are disclosed which relate to a mountable, inline global navigation satellite system receiver module with a standard interface to mobile computing devices and a connection to external antennae. In addition to allowing for data transfer from the receiver module to the mobile computing device, the standard interface is a conduit to power the receiver module and, in some embodiments, the external antennae. Further, a system is disclosed that determines the position coordinates of a mobile computing device via a mountable, inline global navigation satellite system receiver module in communication with the mobile computing device.

### BACKGROUND OF THE INVENTION

1. Field of the Invention

The present invention relates to devices and systems for determining position coordinates using global navigation satellite systems. In particular, the present invention relates to a device which can be placed inline between an external antenna and a mobile computing device.

2. Background of the Invention

Devices which use one particular global navigation satellite system, known as the Global Positioning System (GPS), to determine their position coordinates are well known in the art. Frequently it is desired to interface such a device with a mobile computing device; for example, to display the position coordinates of the device on the display of the mobile computing device. The ability to interface such GPS devices with mobile computing devices is well known in the art, but such devices have shortcomings which undermine their use, especially in vehicle environments or commercial applications.

In vehicle environments, the internal antennas built in to some GPS devices may not be able to adequately pick up a signal if the device is functioning inside a car. As the device is in the car, the antenna may not have access to the open sky. Commercial applications as well sometimes require better accuracy than the built-in antennas of GPS devices can provide. Solutions for powering such a device in a vehicle environment, for example, by using a plug to the vehicle's cigarette lighter socket, can be unwieldy or impossible if the mobile computing device is already using the socket. Porting such a GPS device to a mobile computing device often requires installing additional software to translate the proprietary GPS data format used by the device into a format understandable by the software running on the mobile computing device. Additionally, porting the GPS and mobile computing devices sometimes requires the use of a “RS232” connection between the GPS device and the mobile computing device, though such connections are becoming increasingly rare as they are replaced by more flexible “USB” connections. Finally, in a vehicle environment, the GPS device could be thrown around the vehicle if the vehicle encounters rough terrain. Consumer GPS devices are not designed for the harsh conditions some commercial applications require.

There is thus a need for a GPS device optimized for the conditions present in commercial applications and vehicle environments that overcomes these deficiencies in conventional techniques.

### SUMMARY OF THE INVENTION

The present invention discloses a mountable, inline global navigation satellite system receiver module with a standard interface to mobile computing devices and a connection to external antennae. In addition to allowing for data transfer from the receiver module to the mobile computing device, the standard interface is a conduit to power the receiver module and, in some embodiments, the external antennae.

Further, the present invention discloses a system that determines the position coordinates of a mobile computing device via a mountable, inline global navigation satellite system receiver module in communication with the mobile computing device.

In one exemplary embodiment, the present invention is an inline global navigation satellite system receiving module. The inline global navigation satellite system receiving module includes a housing a global navigation satellite system receiver chip within the housing, an input for a global navigation satellite system antenna coupled to the housing and in communication with the global navigation satellite system receiver chip, and a data port coupled to the housing and in communication with the global navigation satellite system receiver chip. The data port also serves as a power source for the global navigation satellite system receiver chip.

In another exemplary embodiment, the present invention is a system determining a position of a mobile computing device. The system includes an external antenna receiving a plurality of orbital and time data from a plurality of satellites, an inline global navigation satellite system receiving module in communication with the antenna, and a data connection between the global navigation satellite system receiving module and the mobile computing device. The inline receiving module is powered via the data connection, the global navigation satellite system receiving module calculates the mobile computing device position from the received orbital and time data, and the global navigation satellite system receiving module communicates the position of the mobile computing device via the data connection.

In yet another exemplary embodiment, the present invention is a method of delivering position information to a mobile computing device using an inline global navigation satellite system receiving module. The method includes calculating the position of the mobile computing device from received orbital and time data, and sending the position of the mobile computing device via the data connection.

### BRIEF DESCRIPTION OF THE DRAWINGS

FIG. 1A displays a front view of a car equipped with a GPS receiver module inline between an external antenna and laptop computer, according to an exemplary embodiment of the present invention.

FIG. 1B displays a close-up view of GPS receiver module and laptop computer mounted inside the car, according to an exemplary embodiment of the present invention.

FIG. 2 displays the flow of information from the GPS network of satellites to the user application via the GPS receiver module, according to an exemplary embodiment of the present invention.

FIG. 3 displays a close-up view of GPS receiver module and its connections, according to an exemplary embodiment of the present invention.

FIG. 4 displays an internal schematic diagram of the elements that make up the GPS receiver module, according to an exemplary embodiment of the present invention.

### DETAILED DESCRIPTION OF THE INVENTION

The present invention discloses a mountable, inline global navigation satellite system receiver module with a standard interface to mobile computing devices and a connection to external antennae. In addition to allowing for data transfer from the receiver module to the mobile computing device, the standard interface is a conduit to power the receiver module and, in some embodiments, the external antennae.

Further, the present invention discloses a system that determines the position coordinates of a mobile computing device via a mountable, inline global navigation satellite system receiver module in communication with the mobile computing device.

In one exemplary embodiment of the present invention, the global navigation satellite system in communication with the receiver module is GPS and the receiver module interfaces to the mobile computing device via a USB connection. Via a driver installed on the mobile computing device, the receiver module communicates position coordinates of the mobile computing device to software on the mobile computing device using the standard NMEA-0183 GPS communications protocol.

As used herein and throughout this disclosure, a “global navigation satellite system” refers to a system of satellites which continuously transmit sufficient orbital and time data globally for the use of devices in determining their position in space. In an exemplary embodiment of the present invention, the receiver module receives data from the GPS. Examples of other appropriate global navigation satellite systems include Galileo, GLONASS, Beidou/Compass, etc.

As used herein and throughout this disclosure, a “mobile computing device” refers to any portable device which processes received position information in some manner and interfaces to the receiver module. Examples of such mobile computing devices include laptop computers; personal digital assistants (PDAs); netbooks; smartphones; Intelligent Vehicle Device (IVD); Intelligent Field Device (IFD); etc. More specialized mobile computing devices useful for marine or aviation applications include autopilots, chartplotters, fishfinders, or other GPS receivers.

As used herein and throughout this disclosure, a global navigation satellite system “receiver chip” refers to any suitable integrated circuit which calculates its current position coordinates from the satellite signals of a global navigation satellite system received by an antenna communicating with the receiver chip. An example of an acceptable receiver chip is the “NEO 5Q GPS module” produced by UBLOX.

For the following description, it can be assumed that most correspondingly labeled structures across the figures (e.g., 132 and 232, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

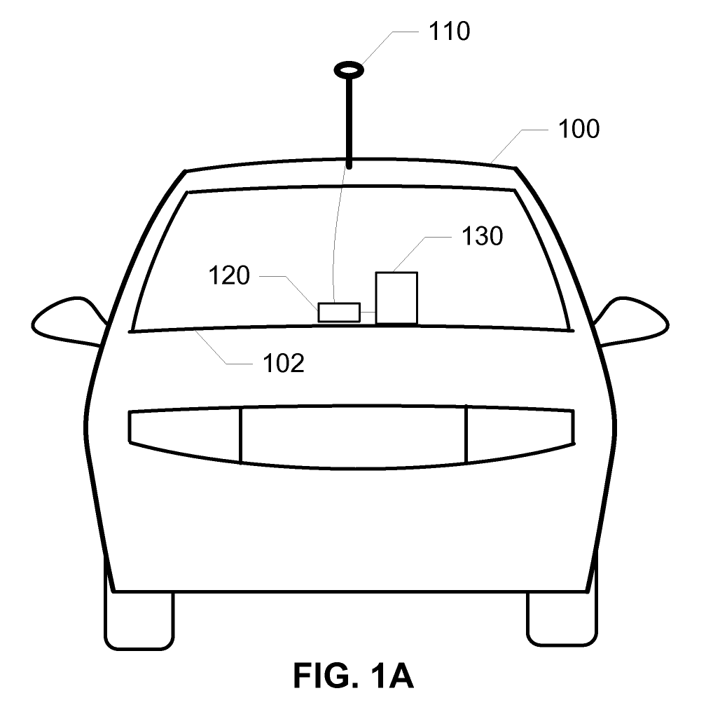

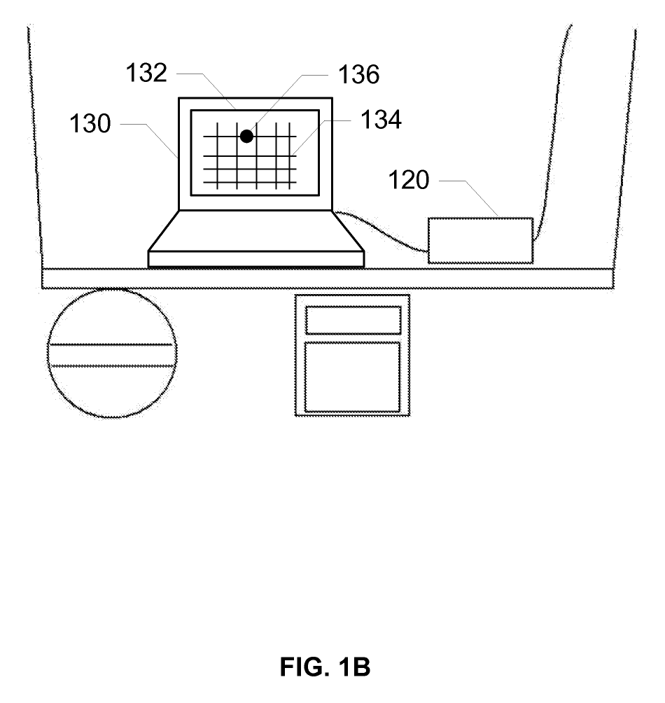

FIG. 1A and FIG. 1B display different views of a system for determining and displaying the position coordinates of a mobile computing device via an inline GPS receiver module. FIG. 1A displays a front view of a car 100 equipped with a GPS receiver module 120 inline between a commercial-grade external antenna 110 and laptop computer 130, according to an exemplary embodiment of the present invention. In this embodiment, GPS receiver module 120 is mounted on a dashboard 102 of car 100. In this embodiment, commercial-grade external antenna 110 is magnetically mounted on the roof of car 100 so that no parts of the car obstruct the reception of signals from GPS satellites by external antenna 110. In this embodiment, laptop computer 130 is powered by the car battery via an inverter which converts the 12 DC voltage of the battery to the 115 V AC voltage used by the laptop computer.

In this embodiment, the GPS receiver module provides a cheap to produce, yet flexible solution for determining the position coordinates of the mobile computing device by virtue of the fact that numerous important functions (such as displaying or processing the calculated position coordinates or receiving the GPS satellite signal) are implemented by external devices, and so do not have to be performed by the GPS receiver module. Nonetheless, by choice of appropriate external devices, including software, the GPS receiver module still has the ability to serve the demands for speed, accuracy, and data storage the user places on it.

FIG. 1B displays a close-up view of GPS receiver module 120 and laptop computer 130 mounted inside the car, according to an exemplary embodiment of the present invention. A display 132 of laptop computer 130 displays a map 134 indicating a current location of the car on the map 136, as determined by GPS receiver module 120. GPS receiver module 120 couples to laptop computer 130 via a standard interface, such as a USB port. GPS receiver module is also coupled to an external antenna to provide a clear signal to GPS receiver 120. Because GPS receiver module 120 is able to connect with other devices, such as laptop computer 130, via a standard interface, a user is able to use various applications on laptop computer 130 that require a GPS location.

Although in the embodiments of FIG. 1A and FIG. 1B, the GPS receiver module is connected to a laptop computer, in other embodiments, the GPS receiver module of the present invention is connected to any other mobile computing device with a USB connection. In another alternative embodiment, instead of mounting the GPS receiver module on the dashboard of the car, the GPS receiver module is mounted directly on the frame of the car, in any location in which its operation is not hindered by the heat generated by the engine of the car. In another alternative embodiment, instead of using a commercial-grade external antenna with the GPS receiver module, a consumer-grade external antenna is used. Examples of acceptable designs for GPS antennas include quad helix and patch designs, in active or passive models. In an alternative embodiment where it is desired to mount the external antenna inside the car without significant loss of GPS signal, a receiving antenna is mounted on the outside of the car and a re-radiating antenna, connected to the receiving antenna via a coaxial cable, is mounted inside the car for transmission to the external antenna connected to the GPS receiver module.

In additional alternative embodiments of the system of FIG. 1A and FIG. 1B, the mobile computing device, in addition to the GPS receiver module and the GPS, interfaces with other devices or networks to enhance the accuracy and/or the time needed to fix the present location of the mobile computing device. In one such alternative embodiment, the mobile computing device interfaces with an accelerometer and odometer whose kinematic data corrects and/or supplements the position coordinates derived from the GPS signal. Such an embodiment is especially useful in applications where the mobile computing device displays an accurate path of the car's motion. In another such alternative embodiment, the mobile computing device maintains a connection to a cellular network such as a mobile phone network. By either triangulating a position in space based on the signals received by nearby cells or by simply noting the position of the cell generating the strongest signal, the approximate (on the order of the cell size) position in space of the mobile computing device determined from the cellular network augments the data determined from the signals generated by the GPS. Such a solution implements an “Enhanced GPS” (EGPS) system, which greatly reduces the time needed for the system to fix its position in space. Other similar alternative embodiments implement “Assisted GPS” (AGPS); “differential GPS” (DGPS); satellite-based augmentation systems such as the Wide Area Augmentation System (WAAS); etc.

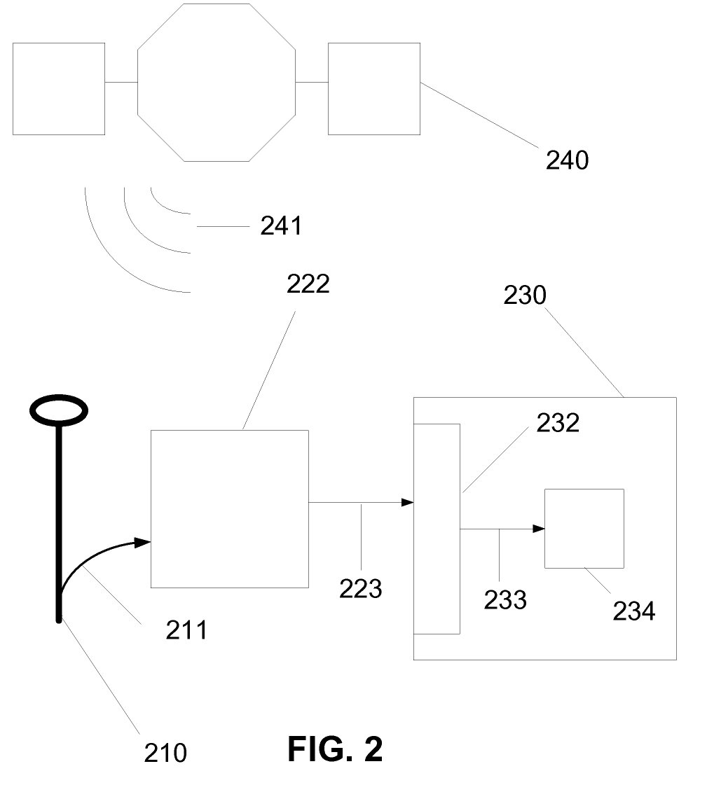

FIG. 2 displays the flow of information from the GPS network of satellites to a user application via the GPS receiver module, according to an exemplary embodiment of the present invention. A plurality of GPS satellites 240 continually radiates a plurality of satellite orbital and time data 241 received by external antenna 210 and transferred to a GPS receiver chip 222 as a radio frequency signal 211. GPS receiver chip 222 processes this signal and produces a plurality of position coordinates 223 of mobile computing device 230. In this embodiment, processing of radio frequency signal 211 includes down converting radio frequency signal 211 into an intermediate frequency (IF) signal; converting the IF signal into a digital signal using an analog-to-digital converter; separating, through correlation decoding, the digital signal into channels corresponding to time-ordered data received from different satellites; extracting the navigational message (including the ephemeris and the time the message was sent) from each channel; and finally implementing an appropriate position calculation algorithm, including correction for errors, using the extracted navigational data from each channel.

The information content of position coordinates 223 include the latitude north or south of the mobile computing device, measured in degrees; the longitude east or west of the mobile computing device, measured in degrees; the height above mean sea level of the mobile computing device, measured in meters; and the time, listed as a Universal Coordinated Time (UTC), at which these position coordinates were recorded. Position coordinates 223 are output to driver 232 which translates them into a plurality of position coordinates in standard data protocol 233 so that they can be transferred to mapping application 234 for display and further processing. Position coordinates in standard data protocol 233 are directly understandable by mapping application 234, and thus do not require any intervening software applications to translate them into the proper format, as proprietary GPS data protocols require when they are used with third party software applications.

In this embodiment, the standard data protocol into which the position coordinates are translated is NMEA-0183. In this embodiment, driver 232 takes the position coordinates 223 transferred via a USB connection to mobile computing device 230 and maps the data flow to a virtual COM port. Common mapping applications compatible with position coordinates written using the NMEA-0183 data protocol include “MICROSOFT Street & Trips”; “GOOGLE Maps Mobile Edition”; “MAPKING”; and “RAND MCNALLY Streetfinder”. In some embodiments, position coordinates 223, after translation, are understood as an Automatic Vehicle Location (AVL) of the vehicle in which mobile computing device 230 operates.

In an alternative embodiment, instead of the receiver module receiving orbital and time data from signals generated by the GPS system, the receiver module receives signals from other global satellite navigation systems, such as Galileo or GLONASS. Although in the embodiment of FIG. 2, the driver running on the mobile computing device translates the position coordinates received from the GPS receiver module into the NMEA-0183 data protocol, in an alternative embodiment, the driver translates the position coordinates into a different standard data protocol such as NMEA-2000. In an alternative embodiment, in addition to receiving and processing position coordinates of the mobile computing device from the GPS receiver module, the driver and mapping application receive and process information pertaining to the ground speed of the mobile computing device from the GPS receiver module, also written using the NMEA-0183 data protocol.

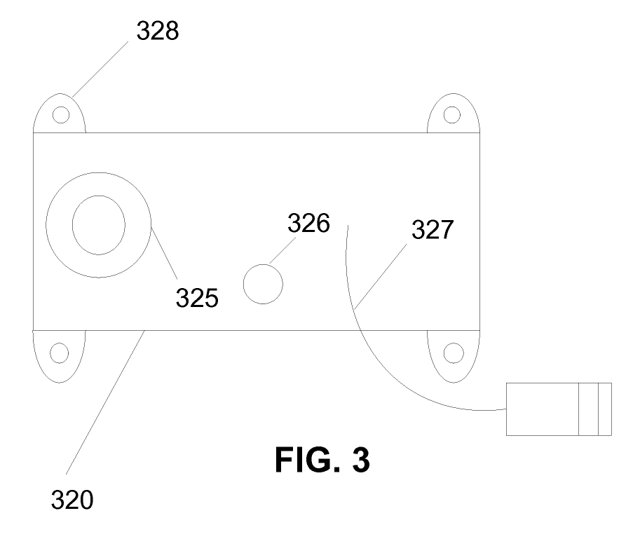

FIG. 3 displays a close-up view of a GPS receiver module 320 and its connections, according to an exemplary embodiment of the present invention. In this embodiment, GPS receiver module 320 has a length of 74 millimeters and a height of 54 millimeters, dimensions small enough for GPS receiver module 320 to be easily mounted via screw holes 328 inside a car interior or to the frame of a car. GPS receiver module has a radio-frequency input 325 which connects to any suitable external GPS antenna that accommodates its connector and a pigtail cable 327 enabling GPS receiver module 320 to interface to a USB connection. In this embodiment, radio frequency input 325 includes a micro-miniature coaxial connector (MMCX) or a SubMiniature version A (SMA) connector. Pigtail cable 327 is 6 feet long to facilitate connection to a mobile computing device. In this embodiment, GPS receiver module 320 is equipped with a green LED power indicator 326 which is lit whenever GPS receiver module receives power via pigtail cable 327.

Although in the embodiment of FIG. 3 the GPS receiver module is mounted via screw holes, in alternative embodiments, other mounting methods are used, depending on the environmental demands on the GPS receiver module. Such environmental considerations include ambient temperature; the composition of the surface to which the GPS receiver module is to be affixed; size requirements; shock requirements; etc. Given these environmental constraints, magnetic mounting; VELCRO; chemical adhesives; etc. are used to mount the GPS receiver module to the car. In another alternative embodiment, the GPS receiver module is not mounted at all, but is portable, although still connected to the mobile computing device and the external antenna. Although in the embodiment of FIG. 3, the radio frequency input is a MMCX or SMA, in an alternative embodiment of the present invention, other suitable radio frequency inputs including miniature coaxial connectors (MCX), BNC connectors, etc. replace it. Further, while a specific size is given for the GPS receiver module, any size of module may be used, depending upon the size constraints of a given environment.

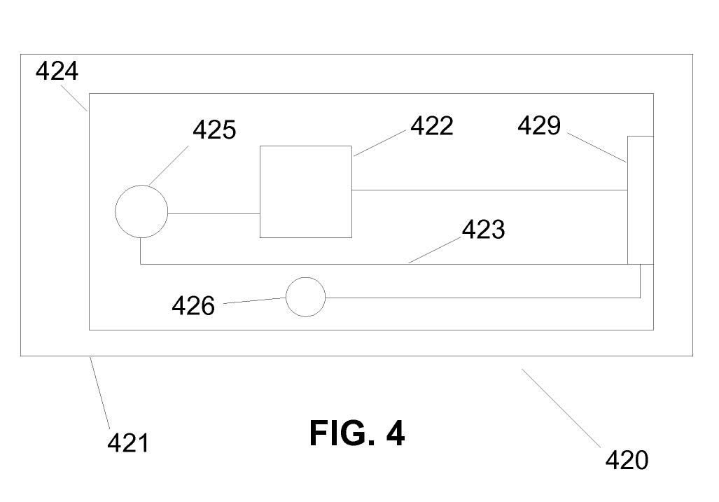

FIG. 4 displays an internal schematic diagram of the elements that make up GPS receiver module 420, according to an exemplary embodiment of the present invention. A metal module 421 acts as the housing of GPS receiver module 420. Metal module 421 is made of a material that is cheap to produce, heat resistant, and durable so that GPS receiver module 420 functions even under the mechanical shocks and high temperatures realized in automotive environments. Mounted inside metal module 421 is a printed circuit board 424 which provides a plurality of electrical connections 423 for data transfer and power to the elements of GPS receiver module 420. Printed circuit board 424 provides for a radio frequency input 425 for an external antenna to GPS receiver chip 422. Printed circuit board 424 provides for a USB output 429 for GPS receiver chip 422. GPS receiver chip 422 outputs position coordinates to the mobile computing device via USB output 429.

In this embodiment, USB output 429 also provides power via printed circuit board 424 to green LED power indicator 426, GPS receiver chip 422, and the external antenna connected to radio frequency input 425. Such an arrangement is useful if the external antenna is an active antenna, thus requiring power for its low noise amplifier (LNA). In this embodiment, GPS receiver module 420 is a “plug and play” device that the operating system of the mobile computing device recognizes when GPS receiver module 420 is connected to the mobile computing device.

Although in the embodiment of FIG. 4 there is an electrical connection for powering the external antenna, in an alternative embodiment where the external antenna is a passive antenna, there is no electrical connection providing power between the USB output and the radio frequency input.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An inline global navigation satellite system receiving module comprising:
a housing;
a global navigation satellite system receiver chip within the housing;
an input for a global navigation satellite system antenna coupled to the housing and in communication with the global navigation satellite system receiver chip; and
a data port coupled to the housing and in communication with the global navigation satellite system receiver chip,
wherein the data port also serves as a power source for the global navigation satellite system receiver chip.

2. The inline global navigation satellite system receiving module of claim 1 wherein the receiving module is mounted via screw holes attached to the surface of the housing.

3. The inline global navigation satellite system receiving module of claim 1 wherein the data port supports a USB connection.

4. The inline global navigation satellite system receiving module of claim 1 wherein the global navigation satellite system is GPS.

5. The inline global navigation satellite system receiving module of claim 1 wherein the global navigation satellite receiving chip communicates using NMEA-0183 data protocol.

6. A system determining a position of a mobile computing device comprising:
an external antenna receiving a plurality of orbital and time data from a plurality of satellites;
an inline global navigation satellite system receiving module in communication with the antenna; and
a data connection between the global navigation satellite system receiving module and the mobile computing device,
wherein the inline receiving module is powered via the data connection; the global navigation satellite system receiving module calculates the mobile computing device position from the received orbital and time data; and the global navigation satellite system receiving module communicates the position of the mobile computing device via the data connection.

7. The system of claim 6 wherein the data connection is a USB connection with associated drivers on the mobile computing device.

8. The system of claim 6 wherein the global navigation satellite system is GPS.

9. The system of claim 6 wherein the receiving module communicates with the mobile computing device using the NMEA-0183 data protocol.

10. The system of claim 6 wherein the receiving module is mounted via screw holes.

11. A method of delivering position information to a mobile computing device using an inline global navigation satellite system receiving module comprising:
calculating the position of the mobile computing device from received orbital and time data; and
sending the position of the mobile computing device via the data connection.

12. The method of claim 11, wherein the sending further comprises using NMEA-0183 data protocol.

13. The method of claim 11, further comprising mounting the inline global navigation satellite system receiving module to the inside of a vehicle.

14. The method of claim 11, further comprising mounting the inline global navigation satellite receiving module to the framework of a vehicle.

15. The method of claim 11, further comprising powering the inline global navigation satellite receiving module via the data connection.
